(19) United States
(12) Patent Application Publication
(10) Pub. No.: US 2026/0126709 A1
(43) Pub. Date: May 7, 2026

(54) CAMERA CONNECTING AND FIXING APPARATUS CAPABLE OF PREVENTING SCREEN OBSTRUCTION, AND ELECTRONIC DEVICE

(71) Applicant: Weisheng YU, Shenzhen (CN)

(72) Inventor: Yuke HUANG, Shenzhen (CN)

(73) Assignee: Weisheng YU, Shenzhen (CN)

(21) Appl. No.: 19/436,420

(22) Filed: Dec. 30, 2025

(30) Foreign Application Priority Data
Dec. 8, 2025 (CN) 202511839650.X

(51) Int. Cl. G03B 17/56

(52) U.S. Cl. CPC G03B 17/561

(57) ABSTRACT

A camera connecting and fixing apparatus capable of preventing screen obstruction comprises a housing, and a lifting and pivoting mechanism and a mounting interface which are connected to the housing. A camera is mounted at an action output end of the lifting and pivoting mechanism. The lifting and pivoting mechanism can be driven by an external force to drive the camera to move upward, move downward and pivot left and right to allow the camera to suspend at any position. The lifting and pivoting mechanism in the present application may be in the form of a folding rod with multiple articulated rods, or in the form of a telescopic rod with one end pivotable. The apparatus is simple in structure and easy to operate. The height and horizontal position of the camera can be adjusted to prevent the camera from obstructing the screen content.

### CROSS-REFERENCE TO RELATED APPLICATIONS

This application claims priority to Chinese Patent Application No. 202511839650.X with a filing date of Dec. 08, 2025. The content of the aforementioned application, including any intervening amendments thereto, is incorporated herein by reference.

### FIELD

The present application relates to the technical field of electronic device accessories, particularly to connection accessories for external cameras, and specifically provides a camera connecting and fixing apparatus capable of preventing display screen obstruction, and an electronic device provided with the camera connecting and fixing apparatus.

### BACKGROUND

With the popularity of telecommuting, online education, live streaming sales and content creation, high-quality video communication has become a rigid demand. As core devices for improving video quality, the requirements for mounting modes of external cameras in application scenarios are becoming increasingly specific and diverse. However, the existing external cameras have relatively single fixing modes and are mostly mounted in single positions or simply fixed with brackets, so that the external cameras often obstruct the screen display content during use, which seriously reduces the visual integrity of users and the interactive efficiency.

For example, a USB computer camera is usually used in conjunction with a desktop computer and is fixed by "clamping" or "placing", a user can directly clamp or place the camera at the center of an upper frame of a display, and some models may be equipped with independent tripods that can be placed on a table top. This connecting and fixing mode has the drawbacks of screen obstructing and rigid layout. Specifically, the camera fixed at the top center of the screen will permanently obstruct the top menu bar, title bar or status bar of an operating system or application; and once the clamping position is determined, it is difficult to finely adjust the clamping position. If the user wants to view the content that is obstructed at the top, the user needs to move the device or his/her own position to avoid obstructing. If the device is moved, the camera needs to be detached, thereby interrupting the video call or recording. If the user moves his/her own position, it will affect the user experience. In addition, if the USB computer camera is applied to a multi-display work scenario, there are also the following defects: the user usually clamps the camera at the top of a main display; and when the user needs to face a secondary display to make presentations or make a call, the viewing angle of the camera becomes very unnatural, making it impossible to achieve a smooth experience of "the camera moving with people".

Therefore, the inventor believes that the fundamental defects of the existing external camera fixing modes can be summarized into the following three points:

1. Contradiction between fixed position and dynamic screen content: The physical position of the camera is static, and the screen display content is dynamically changed. Different applications, full-screen modes and software user interfaces (UIs) may all cause key information to appear in different areas of the screen, and the fixed camera will inevitably cause obstruction in some scenarios.

2. Relying on user adaptation to device, rather than device adaptation to user: When obstruction occurs, the existing solutions require users to move devices, move themselves or adjust software windows. This is an experience of putting the cart before the horse, which transfers inconvenience to users.

3. Lack of specialized flexible solutions: The existing bracket products in the market (such as display bracket arms and microphone cantilevers) are not customized for cameras. The products lack quick-release interfaces suitable for cameras, or the movement ranges and unlocking modes of the products are not suitable for frequent and precise position adjustment.

Therefore, the connecting and fixing technology of existing external cameras has seriously lagged behind the development of their application scenarios, and cannot meet higher requirements of users for screen content integrity, interactive degree of freedom, and professional work efficiency. Therefore, it is necessary to propose a new technical solution to solve the problems existing in the prior art.

### SUMMARY

The present application provides a camera connecting and fixing apparatus capable of preventing screen obstruction, and an electronic device, to solve the problem of inconvenient use resulting from an existing external camera obstructing the screen after being connected and fixed to an electronic device.

In order to achieve the described object, the present application provides the following technical solution:

In one aspect, the present application provides a camera connecting and fixing apparatus capable of preventing screen obstruction, comprising:

a housing, a connecting seat being arranged in an inner cavity of the housing; and

a lifting and pivoting mechanism, one end of the lifting and pivoting mechanism being movably connected with the connecting seat, a mounting seat for mounting a camera being formed at an action output end of the lifting and pivoting mechanism, and the lifting and pivoting mechanism being able to be driven by an external force to drive the camera to move upward, move downward and pivot left and right so as to allow the camera to suspend at any position.

In the described technical solution, further, the lifting and pivoting mechanism comprises a first folding rod and a second folding rod articulated to one end of the first folding rod, the other end of the first folding rod is articulated to the connecting seat, the mounting seat is arranged at the other end of the second folding rod, and the camera is pivotally connected with the mounting seat.

Further, the connecting seat comprises a first fixed shaft fixed in the inner cavity of the housing, a pivot shaft hole adapted to the first fixed shaft is formed at a first end of the first folding rod, and the first folding rod is connected with the first fixed shaft through a first nut and first washers; each of a second end of the first folding rod and a first end of the second folding rod are provided with a pivot shaft hole adapted to a first pivot shaft, the first pivot shaft forms an articulation shaft for the first folding rod and the second folding rod, and two ends of the first pivot shaft are respectively provided with a second washer and a second nut; and the second end of the second folding rod is provided with a pivoting connection hole, and the camera is pivotally connected with the second folding rod through a second pivot shaft.

Further, the first fixed shaft is also provided with a first disk spring; in an axial direction of the first fixed shaft, each of two sides of the first end of the first folding rod is provided with a first washer; the first disk spring is arranged on the side close to a free end of the first fixed shaft, the first nut is in threaded connection with the first fixed shaft, and the first disk spring is located between the corresponding first washer and the first nut; and the second end of the first folding rod and the first end of the second folding rod are corresponding to each other in a front-back direction and are stacked in an axial direction of the first pivot shaft, the first pivot shaft is also provided with a second disk spring, and the second disk spring is arranged between the second nut and the second washer.

Further, the connecting seat also comprises a horizontal slide groove, the horizontal slide groove is provided with a first slide block, the first fixed shaft is fixed on the first slide block, and the lifting and pivoting mechanism can slide back and forth along the horizontal slide groove.

Further, the lifting and pivoting mechanism comprises a telescopic rod, one end of the telescopic rod is provided with a connecting hole, the central axis of the connecting hole is perpendicular to the central axis of the telescopic rod, the telescopic rod is pivotally connected with the connecting seat through a third pivot shaft inserted into the connecting hole, and the third pivot shaft is provided with a washer and an adjustment nut; and the other end of the telescopic rod is provided with a mounting seat for fixing the camera.

Further, the housing is provided with a mounting interface for connecting with an external device.

In another aspect, the present application further provides an electronic device provided with the described camera connecting and fixing apparatus capable of preventing screen obstruction.

Compared with the prior art, the present application at least has the following beneficial effects:

1. On the basis of further analysis and research of the problems in the prior art, it is recognized that the current external camera will obstruct a part of a screen after being fixed; and when users want to view the content of the obstructed part, the users usually solve the problem by moving devices, moving themselves or adjusting software windows, thus bringing inconvenience to the users and affecting the user experience. On this basis, the inventor believes that a dedicated connecting and fixing apparatus capable of preventing screen obstruction by adjusting the position of a camera without relying on user movement should be proposed, and the problem of screen obstruction when the camera is fixed can be solved by the adjustable connecting and fixing structure. Therefore, the present application provides a camera connecting and fixing apparatus capable of preventing screen obstruction. By providing a lifting and pivoting mechanism with multiple degrees of freedom (lifting and pivoting) and an ability to suspend at any position, the camera can be adjusted at any position. Users do not need to change his/her own positions or the positions of main devices and can actively pull the camera to any area next to the screen simply by operating the apparatus lightly. In this case, the height and horizontal position of the camera can be adjusted without moving electronic devices and user positions to prevent the camera from obstructing the screen content and improve the convenience of users, thus fundamentally solving the contradiction between the camera and the screen content competing for space, and also meeting the requirements for cameras nowadays in video content creation such as live streaming.

2. The present application provides two kinds of lifting and pivoting mechanisms, namely a foldable lifting and pivoting mechanism and a telescopic lifting and pivoting mechanism. Articulation shafts of both the lifting and pivoting mechanisms can be provided with disk springs. Damped pivoting is achieved through a friction hinge (or a similar damping structure) adjusted by a disk spring and a nut, so that the weight of a camera (especially a heavy mirrorless camera) can be stably supported after adjustment; when the camera is lightly touched, the position is kept stationary, that is, the static stability is high; and users can apply an appropriate manual force for smooth adjustment, that is, the dynamic flexibility is good.

3. In the present disclosure, multiple degrees of freedom such as horizontal pivot, vertical lifting and horizontal translation are integrated within the limited space through ingenious mechanical design (such as articulation of folding rods, a connecting seat with a slide groove, and a telescopic rod). Users simply need to manually apply a force, and then, the apparatus can complete the camera position adjustment by means of an integrated operation, thus greatly improving the convenience of adjustment and the functional integration degree of the apparatus.

4. In the present disclosure, the housing is provided with a mounting interface for connecting with an external device, and the mounting interface can be detachably connected with the housing. The mounting interface may be a clamping type mounting interface, a magnetic attachment type mounting interface, or the like. By providing the mounting interface, the apparatus can be used for tops of traditional displays, and can also be flexibly adapted to laptop computers (used in conjunction with brackets), gaps of multi-screen workstations, and even independent placement on desktops, thus solving the problem of limited scenarios due to a single fixing mode.

### BRIEF DESCRIPTION OF THE DRAWINGS

To describe the technical solutions in the embodiments of the present application more clearly, the following briefly introduces the accompanying drawings required for the embodiments. It is obvious that the accompanying drawings described below are only some embodiments of the present application. Those of ordinary skill in the art can also obtain other accompanying drawings according to these accompanying drawings without any creative work. It should be understood that the specific shapes and structures shown in the accompanying drawings usually should not be considered as limiting conditions for implementing the present application. For example, those skilled in the art have an ability to easily make conventional adjustment or further optimization to the addition/subtraction/attribution division, specific shapes, position relationships, connection manners, dimensional proportion relationships, and the like of certain units (components) based on the technical concept and exemplary accompanying drawings disclosed in the present application.

FIG. 1 is a schematic view of an overall structure of a camera connecting and fixing apparatus provided in an embodiment of the present application, and a foldable lifting and pivoting mechanism is used in FIG. 1;

FIG. 2 is a schematic structural view after a housing in FIG. 1 is removed;

FIG. 3 is a schematic view of structure disassembly at an articulated part of the lifting and pivoting mechanism in FIG. 2;

FIG. 4 is a schematic view of an overall structure of a camera connecting and fixing apparatus provided in another embodiment of the present application, a telescopic lifting and pivoting mechanism is used in FIG. 4, and arrows in FIG. 4 represent movement directions of a camera; and

FIG. 5 is a structural explosive view of the camera connecting and fixing apparatus provided in FIG. 4.

### Description of reference numerals:

1. housing; 11. connecting seat; 12. first fixed shaft; 13. mounting interface;

2. first folding rod; 3. second folding rod; 4. first pivot shaft; 5. second pivot shaft; 6. camera; 7. telescopic rod; 8. third pivot shaft.

### DETAILED DESCRIPTION OF THE EMBODIMENTS

The present application will be further described in detail below through specific embodiments with reference to the accompanying drawings.

In the description of the present application, unless otherwise specified, "a plurality of" means two or more. The terms "first", "second", and the like used in the present application are intended to distinguish the objects referred to, and do not have any special meaning in terms of technical connotation (for example, should not be understood as emphasizing the importance or order). The expressions "comprising", "containing", "having", and the like also imply "not limited to" (certain units, components, materials, steps, and the like).

The terms used in the present application, such as "up", "down", "left", "right", "middle", "front" and "back", are usually used for the purpose of facilitating intuitive understanding with reference to the accompanying drawings, and are not an absolute limitation on position relationships in actual products. Without departing from the technical concept disclosed in the present application, changes in these relative position relationships are also considered within the scope of the present application.

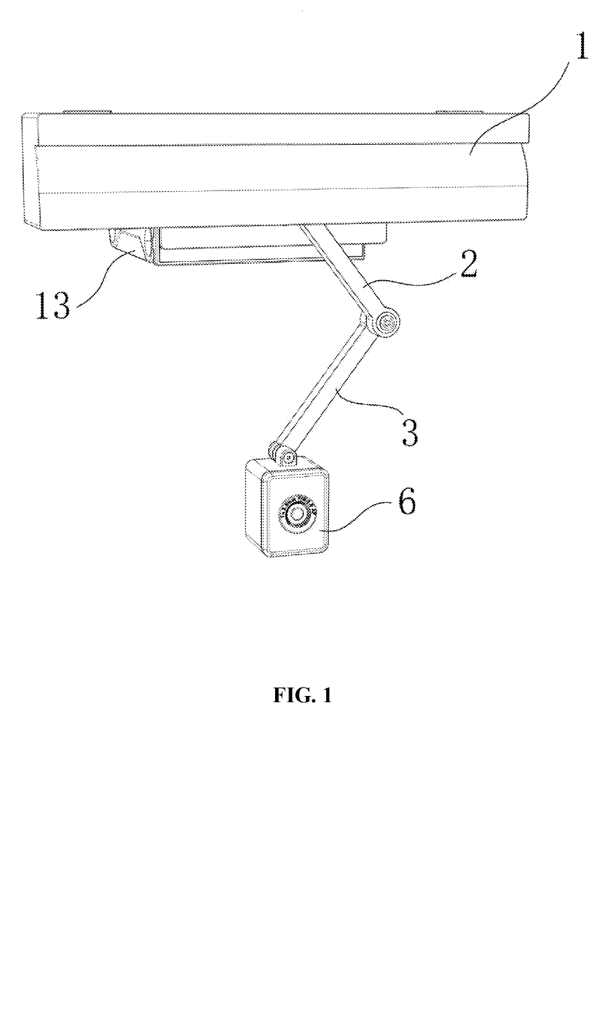

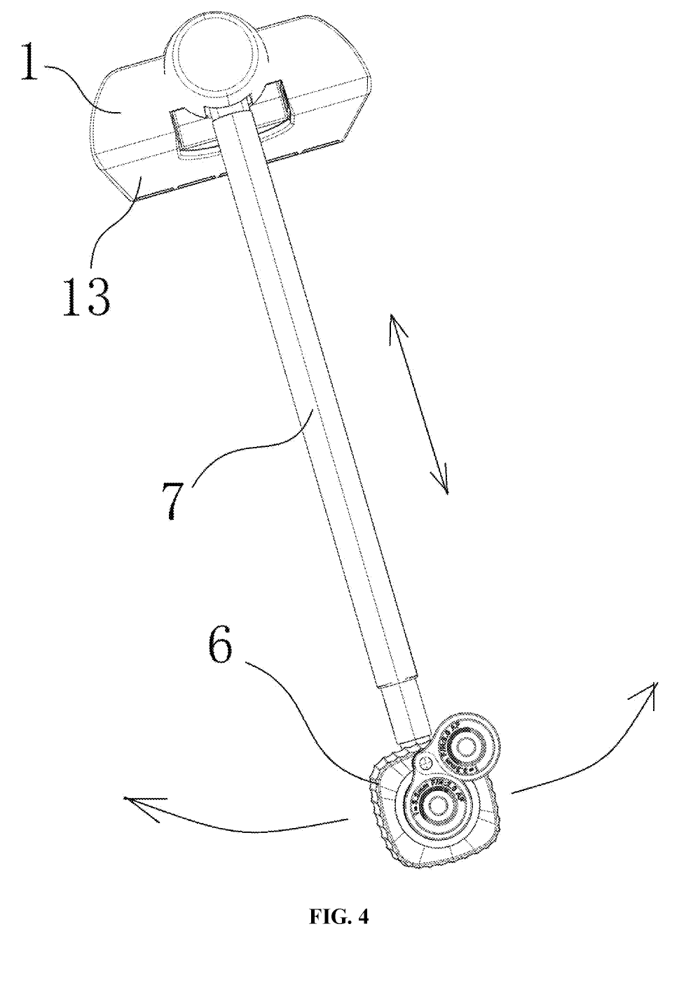

The present application provides a camera connecting and fixing apparatus capable of preventing screen obstruction, comprising a housing 1 and a lifting and pivoting mechanism mounted on the housing 1. Specifically, a connecting seat 11 is arranged in an inner cavity of the housing 1; one end of the lifting and pivoting mechanism is movably connected with the connecting seat 11, and a mounting seat for mounting a camera 6 is formed at an action output end of the lifting and pivoting mechanism; and the lifting and pivoting mechanism can be driven by an external force to drive the camera 6 to move upward, move downward and pivot left and right so as to allow the camera 6 to suspend at any position, as shown in FIG. 1 or FIG. 4.

The camera connecting and fixing apparatus capable of preventing screen obstruction mainly comprises the housing 1, the connecting seat 11 and the lifting and pivoting mechanism. The housing 1 serves as a base of the entire apparatus, and can be stably fixed on an electronic device (such as an upper frame of a display) or a fixed base (such as a table top or surfaces of other devices) through a mounting interface 13 (such as a clamp, a magnetic holder, or a 3M adhesive) arranged at the rear or bottom of the housing 1. The connecting seat 11 is fixed in the housing 1, and provides a stable pivoting or sliding support point for the lifting and pivoting mechanism. The lifting and pivoting mechanism is a core moving component, one end of the lifting and pivoting mechanism is connected with the connecting seat 11, and the other end of the lifting and pivoting mechanism is provided with the mounting seat for mounting the camera 6. Users can manually apply an external force (such as a pushing force, a pulling force or a rotating force) to the lifting and pivoting mechanism or the camera to drive the entire mechanism to move. The mechanism is designed to provide uniform damping throughout the entire movement to allow the camera to smoothly move to a target position in the three-dimensional space (mainly vertical lifting and horizontal pivoting); and once the external force is removed, the camera reliably suspends by means of an internal friction torque of the mechanism at the current position without drifting or falling.

The camera connecting and fixing apparatus capable of preventing screen obstruction, provided in the present application, solves the problems of single fixed position and easy obstruction of screen content of an existing external camera. Users do not need to move display devices or his/her own positions and can flexibly move the camera from a position that may obstruct key areas of the screen (such as a software menu bar, a video title and a chat window) to blank areas such as the side and top of the screen simply by adjusting the apparatus in the present disclosure, so as to realize the purpose that "the camera makes way for the screen content", thereby greatly improving the user experience and operation efficiency in scenarios such as video conference, live streaming and content creation.

Specifically, the camera 6 may be detachably connected with the mounting seat through threaded holes and bolts or through quickly-release plates, magnetic attachment and other modes, and is compatible with mainstream USB cameras, network conference cameras and even mirrorless cameras on the market. Preferably, the camera 6 is pivotally connected with the mounting seat through a pivot shaft to facilitate the adjustment of the angle of the camera.

On the basis of the described technical solution, there are various implementations for the specific structure of the lifting and pivoting mechanism. The specific structure of the lifting and pivoting mechanism will be described in detail below with reference to specific embodiments.

### Embodiment 1

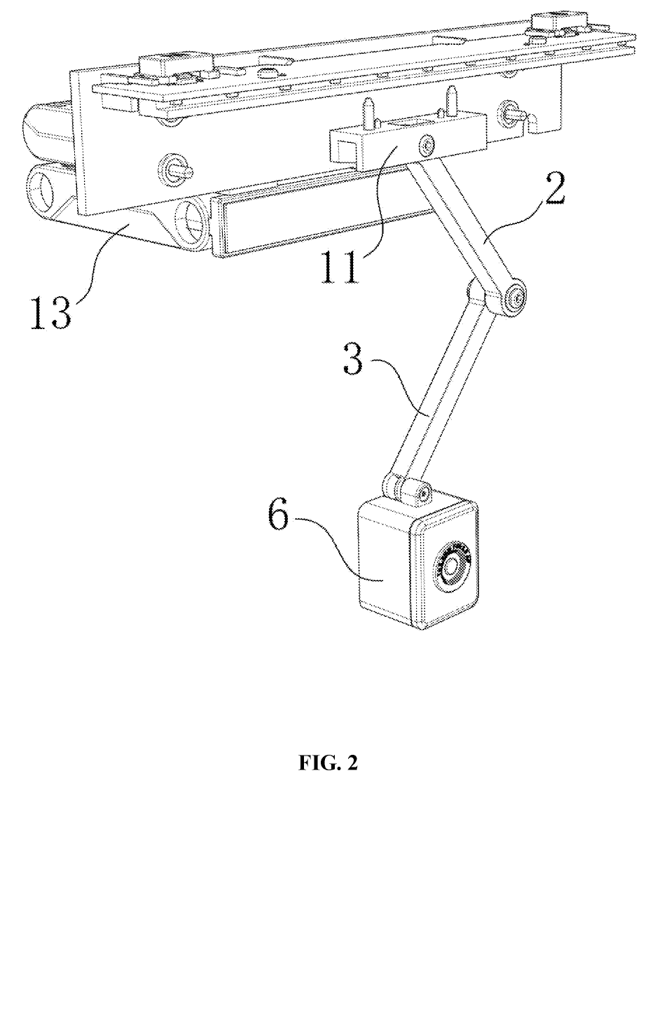

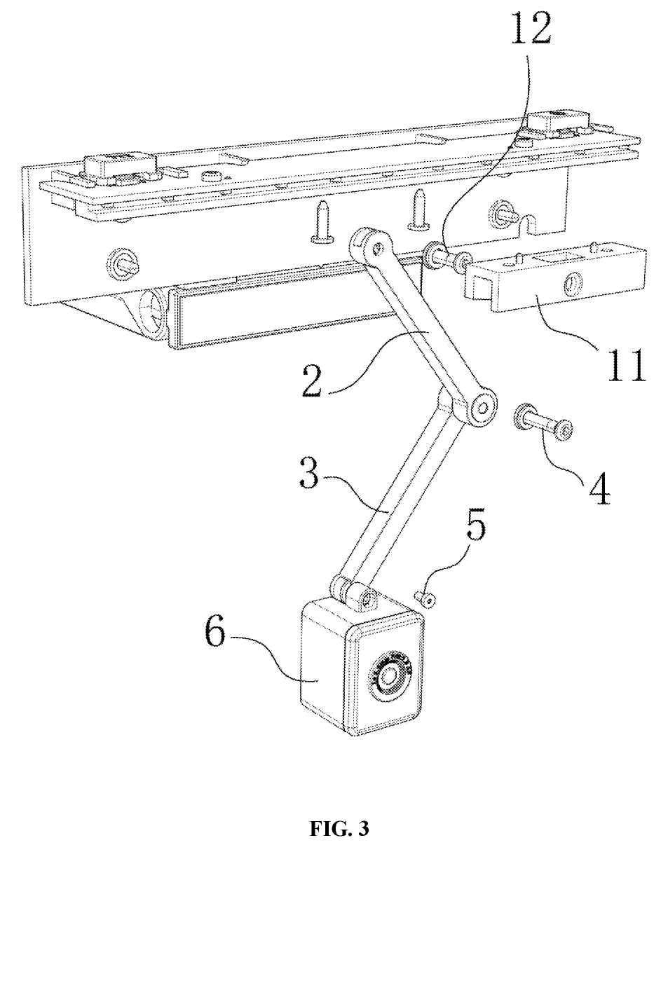

In this embodiment, referring to FIG. 1 to FIG. 3, a lifting and pivoting mechanism comprises a first folding rod 2 and a second folding rod 3 articulated to one end of the first folding rod 2. The other end of the first folding rod 2 is articulated to a connecting seat 11 in a housing 1, and the other end of the second folding rod 3 is provided with a mounting seat for mounting a camera 6. The camera 6 can be pivotally connected with the mounting seat through a pivot shaft to improve the flexibility of angle adjustment of the apparatus.

The connecting seat 11 comprises a first fixed shaft 12 fixed in an inner cavity of the housing 1. A pivot hole adapted to the first fixed shaft 12 is formed at a first end of the first folding rod 2, and the first folding rod 2 is connected with the first fixed shaft 12 through a first nut and first washers, so that the first folding rod 2 pivots relative to the housing 1.

Each of a second end of the first folding rod 2 and a first end of the second folding rod 3 is provided with a pivot shaft hole adapted to a first pivot shaft 4, the first pivot shaft 4 serves as an articulation shaft for the first folding rod 2 and the second folding rod 3, and two ends of the first pivot shaft 4 are respectively provided with a second washer and a second nut. Through the articulation point, users can fold or unfold the first folding rod 2 and the second folding rod 3 to achieve the lifting movement of the camera 6.

The second end of the second folding rod 3 is provided with a pivoting connection hole, and the camera 6 is pivotally connected with the second folding rod 3 through a second pivot shaft 5, so as to achieve the adjustment of the angle of the camera 6. In a specific embodiment, the central axis of the second pivot shaft 5, the central axis of the first pivot shaft 4 and the central axis of the first fixed shaft 12 are parallel, and the lifting and pivoting mechanism moves upward, moves downward and pivots left and right in a plane perpendicular to the first fixed shaft 12.

In another specific embodiment, the central axis of the first fixed shaft 12 is parallel to the central axis of the first pivot shaft 4, and the central axis of the second pivot shaft 5 is perpendicular to the central axis of the first fixed shaft 12. In this case, the folding mechanism formed by the first folding rod 2 and the second folding rod 3 moves upward, moves downward and pivots left and right in a plane perpendicular to the first fixed shaft 12, and the camera 6 can pivot back and forth through the second pivot shaft 5 to achieve pitch angle adjustment of the camera.

In a preferred embodiment, in order to provide required damping during adjustment and achieve self-locking after adjustment, a disk spring (not shown) is introduced in the articulation structure. Specifically,

the first fixed shaft 12 is also provided with a first disk spring. In an axial direction of the first fixed shaft 12, each of two sides of the first end of the first folding rod 2 is provided with a first washer, the first disk spring is arranged on the side close to a free end of the first fixed shaft 12, the first nut is in threaded connection with the first fixed shaft 12, and the first disk spring is located between the corresponding first washer and the first nut. The first disk spring can be compressed or released by tightening or loosening the first nut, thereby changing the friction torque of the first folding rod 2 pivoting around the first fixed shaft 12.

Similarly, the first pivot shaft 4 is also provided with a second disk spring. The second end of the first folding rod 2 and the first end of the second folding rod 3 are corresponding to each other in a front-back direction and are stacked in an axial direction of the first pivot shaft 4. The second disk spring is arranged between the second nut and the adjacent second washer. The tightness of articulation between the first folding rod 2 and the second folding rod 3 can be controlled by adjusting the tightness of the second nut, thereby adjusting the damping and holding force of the lifting movement.

As mentioned above, a disk spring can also be introduced on the second pivot shaft 5 on which the camera 6 is mounted, so as to change the pivot friction torque between the camera 6 and the lifting and pivoting mechanism.

According to the camera connecting and fixing apparatus using the lifting and pivoting mechanism provided in this embodiment, by means of the pivot fitting between the two folding rods and the first fixed shaft 12, the first pivot shaft 4 and the second pivot shaft 5, the camera 6 can be pushed to a top position to be away from a screen area, so as to eliminate obstruction. In multi-display work scenarios, the camera 6 can be pushed to an appropriate position to achieve a smooth experience of "the camera 6 moving with people".

In addition, according to the camera connecting and fixing apparatus in this embodiment, the camera 6 can be flexibly positioned in a large range in the space in front of the screen by means of the pivoting fit between the two folding rods and the first fixed shaft 12, the first pivot shaft 4 and the second pivot shaft 5. The function, which can achieve visual angle adjustment of the camera in the space in front of the screen and large-range position translation in the horizontal plane, is highly valuable in live streaming scenarios.

For example, in a single-person live streaming scenario, a live streamer can fix the apparatus on the top of a main display. During normal personal live streaming, the camera 6 can be placed directly above the screen to obtain a standard front view. When the live streaming content needs to change the composition or interact with specific areas of the screen (for example, the live streamer needs to point to the barrage comment area or product link on one side of the screen for explanation), the live streamer can use the folding rod mechanism with one hand to horizontally pivot the camera 6 and lower the camera 6 to a blank area on the left side or right side of the screen. This operation ensures that when the live streamer points to the screen content, the direction of the line of sight of the live streamer is basically the same as the direction of the optical axis of the camera, thereby providing audiences with a natural impression of "the live streamer is looking at you in front of the screen for communication", rather than a sense of detachment of the line of sight from the camera. The ability to flexibly adjust the position of the camera within the plane in front of the screen is an important guarantee for achieving professional live streaming interactive effects. Therefore, the camera connecting and fixing apparatus in this embodiment can assist the live streamer in conveniently positioning the camera in the space in front of the screen at will, so as to meet the requirements for live streaming cameras and improve the live streaming effect.

### Embodiment 2

Embodiment 2 serves as a further optimization of Embodiment 1. In order to provide a larger horizontal adjustment range, the structure of the connecting seat 11 is improved in this embodiment. Specifically, the connecting seat 11 of the housing 1 also comprises a horizontal slide groove. The horizontal slide groove is provided with a first slide block, and the first fixed shaft 12 for connecting with the first folding rod 2 is fixed on the first slide block. In this way, the lifting and pivoting mechanism as a whole can slide back and forth along the horizontal slide groove, thereby achieving the translational degree of freedom of the camera 6 in the horizontal direction, and further expanding the adjustment range of the camera 6 capable of avoiding the screen obstruction.

In a specific application example, a locking screw can be arranged between the first slide block and the horizontal slide groove to fix the position of the first slide block. For example, the first slide block is machined to form a threaded through hole, a continuous strip-shaped clearance hole or groove is formed on the top or on a side of the horizontal slide groove corresponding to the movement trajectory of the slide block to allow a rod part of the locking screw to pass through, and also provide a clearance space for the head of the locking screw or a nut; a hand-screw locking screw is allowed to pass through the clearance hole of the horizontal slide groove and is screwed into the threaded hole of the slide block. When the locking screw is rotated counterclockwise, the head of the locking screw is detached from or is in slight contact with the surface of the slide groove, and at this time, the slide block can move freely in the slide groove. When the locking screw is screwed clockwise, the head of the screw can clamp the side wall of the slide groove between the head of the screw and the slide block to generate a large static friction force, so as to prevent the slide block from moving. Of course, other locking structures can also be used to achieve the locking of the slide block with the horizontal slide groove in place.

### Embodiment 3

Compared to the foldable lifting and pivoting mechanism provided in Embodiment 1 or Embodiment 2, this embodiment provides a telescopic lifting and pivoting mechanism.

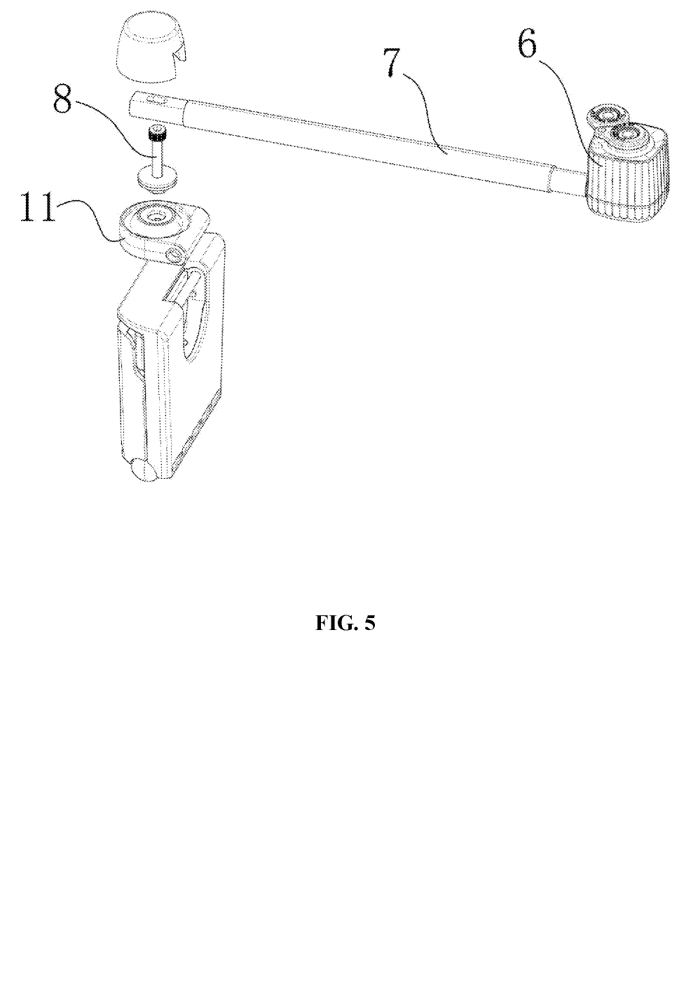

In this embodiment, referring to FIG. 4 and FIG. 5, the lifting and pivoting mechanism comprises a telescopic rod 7. One end of the telescopic rod 7 is provided with a connecting hole, the central axis of the connecting hole is perpendicular to the central axis of the telescopic rod 7, the telescopic rod 7 is pivotally connected with a connecting seat 11 through a third pivot shaft 8 inserted into the connecting hole, and the third pivot shaft 8 is provided with a washer and an adjustment nut. Through this structure, the telescopic rod 7 can pivot left and right as a whole around the third pivot shaft 8; this action works together with the telescopic function of the telescopic rod 7, such that the camera 6 mounted thereon can be driven to move upward, move downward and pivot left and right.

In this embodiment, the other end of the telescopic rod 7 is provided with a mounting seat for mounting the camera 6, and the camera 6 can be tightly connected with the mounting seat through bolts or can be pivotally connected with the mounting seat through a pivot shaft or universal connector.

In this embodiment, the telescopic rod 7 may have a multi-section telescopic tube structure, and the length adjustment and fixation are achieved through internal pneumatic springs and friction locking or knob locking mechanisms (all of which are mature existing technologies, not elaborated in detail in the figures), thereby driving the camera 6 to move up and down.

In this embodiment, the connecting seat 11 can be pivotally mounted on the housing 1 through a pivot shaft, so that the lifting and pivoting mechanism as a whole can pivot relative to the housing. Of course, a guide rail may also be provided, and the connecting seat is mounted on the guide rail of the housing, so that the lifting and pivoting mechanism as a whole can translate in a horizontal plane relative to the housing.

According to the camera connecting and fixing apparatus using the lifting and pivoting mechanism provided in this embodiment, through the pivoting fit between the telescopic rod 7 and the third pivot shaft 8, the telescopic rod 7 is extended, and the camera 6 is pushed to a top horizontal position to avoid screen obstructing areas. In multi-display work scenarios, the camera can be pulled to an appropriate position to achieve a smooth experience of "the camera moving with people".

In addition, the camera connecting and fixing apparatus in this embodiment can greatly expand the movement radius of the camera 6 through the pivoting fit between the telescopic rod 7 and the third pivot shaft 8, which is particularly advantageous in scenarios where multiple displays are used for live streaming or where camera positions need to be adjusted in a large range.

For example, in a multi-display live streaming scenario, a live streamer can mount the apparatus of the present disclosure at the top end of a main display. During conventional live streaming, the camera 6 is placed next to the main display. When it is necessary to switch to the content on a secondary display (such as presentations, codes or reference videos) and provide explanations, the live streamer can easily pull out the telescopic rod 7 and cause the telescopic rod 7 to pivot horizontally to quickly and accurately translate the camera 6 to the front of the secondary display, thereby switching the viewing angle accordingly. The entire process does not require the movement of any display or camera base, thereby really achieving "the camera moving with the content", and ensuring the consistency and professionalism of the live streaming process. In addition, the telescopic rod structure allows the live streamer to perform body movement within an appropriate range (such as gesture demonstration of a small amplitude) in front of the camera, and the camera can be finely adjusted to always keep the live streamer at the center of the screen, while a traditional fixed camera is prone to causing a person to appear outside the screen. Therefore, the telescopic rod type camera fixing apparatus provided in this embodiment can achieve large-range displacement of the position of the camera and is suitable for multi-screen scenarios.

In each of the described embodiments, the housing 1 is provided with a mounting interface 13 for connecting with an external device. The mounting interface 13 may be a clamping structure suitable for an upper frame of a display, a strong magnetic bracket suitable for a smooth surface, or a mount suitable for a table top, so as to ensure the overall mounting stability. Or, the mounting interface 13 is detachably connected with the housing 1, so that the apparatus of the present disclosure can be adapted to various application scenarios by replacing the mounting interface with different mounting interfaces.

### Embodiment 4

The present application further provides an electronic device. The electronic device is provided with any one of the camera connecting and fixing apparatuses capable of preventing screen obstruction in the described technical solutions. The electronic device includes but is not limited to desktop computer displays, all-in-one computers, laptop computers (being used in conjunction with stands), multi-screen workstations, and the like.

Therefore, the present application provides a camera connecting and fixing apparatus capable of preventing screen obstruction. The apparatus can achieve flexible adjustment of the position of a camera, thereby preventing the screen from being obstructed and improving the use convenience. In addition, the apparatus can be applied to various scenarios to meet diversified camera mounting requirements at present. Furthermore, the apparatus is simple in structure and easy to operate, has a flexible and smooth adjustment process, does not affect the fixing stability of the camera, and has strong practicability.

The technical features of the described embodiments can be combined arbitrarily (as long as there is no contradiction in the combinations of these technical features). In order to make the description concise, not all possible combinations of the technical features in the described embodiments are described. These unspecified embodiments should also be considered within the scope of the specification.

The text hereinabove provides a specific and detailed description of the present application through general explanations and specific embodiments. It should be understood that based on the technical concept of the present application, several conventional adjustments or further innovations can also be made to these specific embodiments. However, without departing from the technical concept of the present application, the technical solutions obtained by these conventional adjustments or further innovations also fall within the scope of protection of the claims of the present application.

What is claimed is:

1. A camera connecting and fixing apparatus capable of preventing screen obstruction, comprising:
a housing, a connecting seat being arranged in an inner cavity of the housing; and
a lifting and pivoting mechanism, one end of the lifting and pivoting mechanism being movably connected with the connecting seat, a mounting seat for mounting a camera being formed at an action output end of the lifting and pivoting mechanism, and the lifting and pivoting mechanism being able to be driven by an external force to drive the camera to move upward, move downward and pivot left and right so as to allow the camera to suspend at any position.

2. The camera connecting and fixing apparatus capable of preventing screen obstruction according to claim 1, wherein the lifting and pivoting mechanism comprises a first folding rod and a second folding rod articulated to one end of the first folding rod, another end of the first folding rod is articulated to the connecting seat, the mounting seat is arranged at the another end of the second folding rod, and the camera is pivotally connected with the mounting seat.

3. The camera connecting and fixing apparatus capable of preventing screen obstruction according to claim 2, wherein the connecting seat comprises a first fixed shaft fixed in the inner cavity of the housing, a pivot shaft hole adapted to the first fixed shaft is formed at a first end of the first folding rod, and the first folding rod is connected with the first fixed shaft through a first nut and first washers;
each of a second end of the first folding rod and a first end of the second folding rod are provided with a pivot shaft hole adapted to a first pivot shaft, the first pivot shaft forms an articulation shaft for the first folding rod and the second folding rod, and two ends of the first pivot shaft are respectively provided with a second washer and a second nut; and
the second end of the second folding rod is provided with a pivoting connection hole, and the camera is pivotally connected with the second folding rod through a second pivot shaft.

4. The camera connecting and fixing apparatus capable of preventing screen obstruction according to claim 3, wherein the first fixed shaft is also provided with a first disk spring; in an axial direction of the first fixed shaft, each of two sides of the first end of the first folding rod is provided with a first washer; the first disk spring is arranged on the side close to a free end of the first fixed shaft, the first nut is in threaded connection with the first fixed shaft, and the first disk spring is located between the corresponding first washer and the first nut; and
the second end of the first folding rod and the first end of the second folding rod are corresponding to each other in a front-back direction and are stacked in an axial direction of the first pivot shaft, the first pivot shaft is also provided with a second disk spring, and the second disk spring is arranged between the second nut and the second washer.

5. The camera connecting and fixing apparatus capable of preventing screen obstruction according to claim 3, wherein the connecting seat further comprises a horizontal slide groove, the horizontal slide groove is provided with a first slide block, the first fixed shaft is fixed on the first slide block, and the lifting and pivoting mechanism is capable of sliding back and forth along the horizontal slide groove.

6. The camera connecting and fixing apparatus capable of preventing screen obstruction according to claim 1, wherein the lifting and pivoting mechanism comprises a telescopic rod, one end of the telescopic rod is provided with a connecting hole, a central axis of the connecting hole is perpendicular to a central axis of the telescopic rod, the telescopic rod is pivotally connected with the connecting seat through a third pivot shaft inserted into the connecting hole, and the third pivot shaft is provided with a washer and an adjustment nut; and another end of the telescopic rod is provided with a mounting seat for fixing the camera.

7. The camera connecting and fixing apparatus capable of preventing screen obstruction according to claim 1, wherein the housing is provided with a mounting interface for connecting with an external device.

8. An electronic device, provided with the camera connecting and fixing apparatus capable of preventing screen obstruction according to claim 1.
